(19) United States
(12) Patent Application Publication
(10) Pub. No.: US 2009/0143097 A1
(43) Pub. Date: Jun. 4, 2009

(54) PCB coil for hearing aid compatibility compliance

(75) Inventor: David Wilson, Soquel, CA (US)

Correspondence Address: FOLEY & LARDNER LLP, 777 EAST WISCONSIN AVENUE, MILWAUKEE, WI, 53202-5306, US

(73) Assignee: Palm, Inc.

(21) Appl. No.: 11/998,868

(22) Filed: Nov. 30, 2007

(51) Int. Cl. H04M 1/00

(52) U.S. Cl. 455/556.1

(57) ABSTRACT

A wireless phone includes a wireless transceiver that facilitates wireless transfer of signals containing audio information. The wireless transceiver receives signals containing audio information and a processing circuit coupled to the wireless transceiver receives audio data based on the audio signals and provides output audio signals. The phone also includes a coil formed in a circuit carrying element (e.g. circuit board). The coil receives a signal based on the output audio signals from the processing circuit and, in response, provides an output signal receivable by a hearing aid that is not intelligible by a human ear. The coil may be one of multiple coils of a coil system formed in multiple layers of the circuit carrying element.

### BACKGROUND OF THE INVENTION

The present invention relates generally to the field of hearing aid compatible devices.

Typical receiver transducers from phone handsets may be difficult for hearing aids to pick up, making use of a standard phone with a hearing aid more difficult. To overcome this problem, many hearing aids use a telecoil to amplify voice signals received from a telephone's receiver transducer by coupling to a magnetic field produced by the receiver transducer during use and reproducing the sound produced by the receiver transducer using the magnetically coupled signal. The hearing aid then converts the received signal into an audible (sound) signal and may further reproduce the audible signals at the volume set by the user. Many hearing aids allow a user to switch between a normal listening mode where the hearing aid detects and amplifies sound received by the hearing aid, and a telecoil mode where the hearing aid uses the telecoil to produce the sound provided to the user.

Although wireless phones were previously exempt from being compatible with hearing aids, the Federal Communications Commission (FCC) has modified the previous exemption for wireless phones under the Hearing Aid Compatibility (HAC) Act of 1988 to require that wireless phone manufacturers and wireless phone service providers make digital wireless phones accessible to individuals who use hearing aids. Wireless phones which meet this new requirement are sometimes referred to as HAC-compliant.

Telecoils used in typical land-line telephone headsets produce a magnetic field in the direction of an induction coil of a hearing aid worn by the telephone's user. The telecoil produces the magnetic field to reduce an amount of feedback (e.g., whistle, hum, etc.) generated when an object such as a telephone handset is placed in close proximity to the hearing aid's microphone. The hearing aid's telecoil couples to the magnetic field and uses this magnetic field to provide a desired tone quality.

### BRIEF DESCRIPTION OF THE DRAWINGS

J FIG. 1 is a component diagram of a hearing aid compatible mobile phone according to one embodiment;

FIG. 2 is a diagram of applications of a hearing aid compatible mobile phone according to one embodiment;

FIG. 3 is a diagram of a circuit carrying element including an integrated coil according to one embodiment;

FIG. 4 is a diagram of a multilayer circuit carrying element including an integrated coil according to one embodiment;

FIG. 5 is a diagram of a circuit carrying element including an integrated coil according to one embodiment;

FIG. 6 is a circuit diagram for powering an integrated coil and a receiver transducer according to one embodiment;

FIG. 7 is a circuit diagram for powering an integrated coil and a receiver transducer according to one embodiment;

FIG. 8 is a circuit diagram for powering an integrated coil and a receiver transducer according to one embodiment;

FIG. 9 is a circuit diagram for powering an integrated coil and a receiver transducer according to one embodiment;

FIG. 10A is an illustration of a front side of a mobile phone according to one embodiment;

FIG. 10B is an illustration of a back side of a mobile phone according to the embodiment of FIG. 10A;

FIG. 10C is an illustration of a bottom side and front side of a mobile phone according to the embodiment of FIG. 10A;

FIG. 10D is an illustration of a top side and front side of a mobile phone according to the embodiment of FIG. 10A;

FIG. 10E is an illustration of a left side of a mobile phone according to the embodiment of FIG. 10A;

### DETAILED DESCRIPTION OF THE PREFERRED EMBODIMENTS

Referring to FIG. 3, a circuit carrying element 210 includes a coil system 214 formed on the circuit carrying element. Coil system 214 is configured to be driven by an audio drive circuit 212 so that coil system provides a wireless signal that is detectable by a hearing aid. The wireless signal may be a type of signal that is not intelligible by a human ear (i.e. a typical human ear would not be able to detect and/or decipher the content of the signal without strain). For example, coil system 214 may be configured to provide a magnetic signal that is detectable by a telecoil of a hearing aid. The coil system may be configured to provide a magnetic signal containing an RF component.

Coil system 214 may be formed on the circuit carrying element 210 by any number of means. For example, coil system 214 may be formed on circuit carrying element by etching the coil out of the circuit carrying element, by vapor deposition of the coil on the circuit carrying element, by printing the coil on the circuit carrying element, by electroplating the coil on the circuit carrying element, or by some other process for forming current carrying leads on a circuit carrying element.

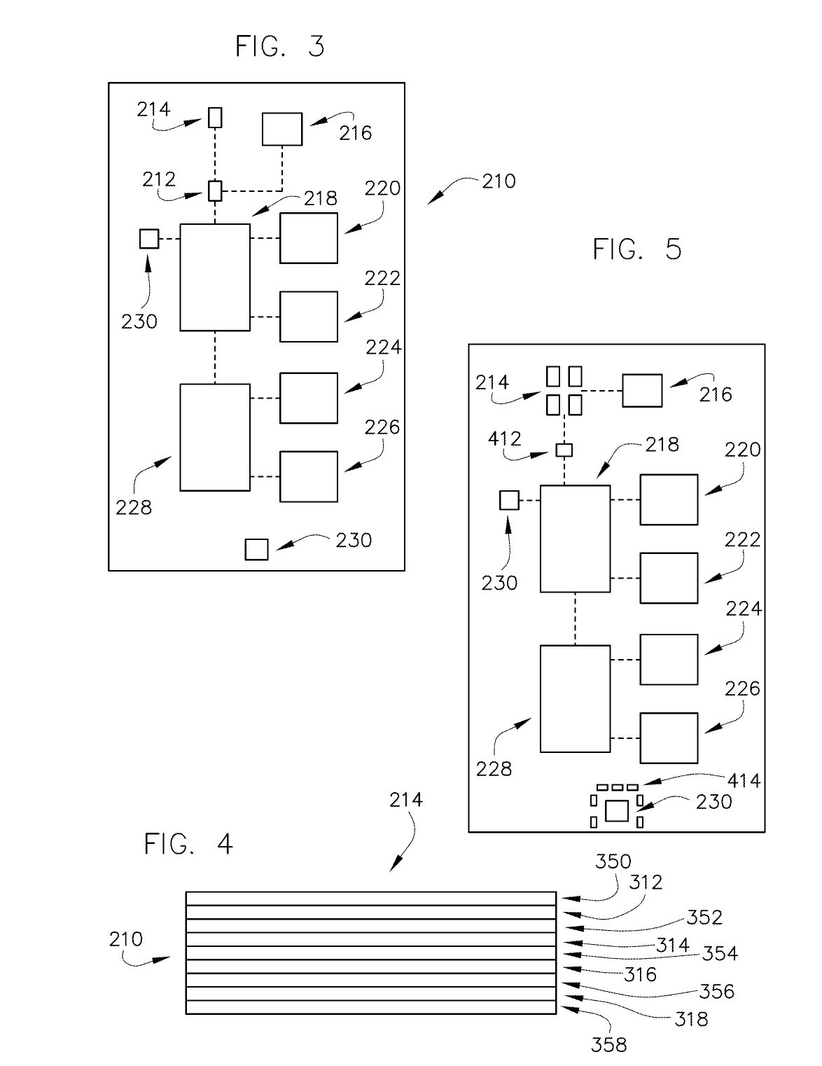

Coil system 214 may contain a single coil or may include multiple coils. A coil system 214 having multiple coils may have the multiple coils arranged such that the signal (e.g. magnetic signal) produced by the coils is additive. For example, referring to FIGS. 3 and 4, the coils may be arranged on multiple layers 312-318 (FIG. 4) of a multilayer circuit carrying element 210. The coils may be arranged such that the individual coils overlap at least one, at least two, and/or at least three coils along a line that is not parallel to a surface of the circuit carrying element 210 on which at least one of the coils is placed (e.g. a line substantially perpendicular to a surface of the circuit carrying element 210 on which at least one of the coils is placed). A coil of a multilayer coil system 214 may be located on an external surface of an external non-conductive (e.g. insulating) layer 312, 318 of the circuit carrying element 210, or may be formed in an internal conductive layer 352,356 of the circuit carrying element 210 on an internal surface of an external non-conductive layer 312,318 or on only surfaces of internal non-conductive layers 314,316.

A multilayer coil system 214 may include at least one coil in each conductive layer 350-358 of a multilayer circuit carrying element 210, may include a coil in at least half the conductive layers 350-358 of a multilayer circuit carrying element 210 (rounding up), may include a coil in at least one third of the conductive layers 350-358 of a multilayer circuit carrying element 210 (rounding Up), may include a coil in at least one quarter of the conductive layers 350-358 of a multilayer circuit carrying element 210 (rounding up), etc. Two, three, four, or more of the coils of a multilayer coil system 214 may be located on adjacent conductive layers 350-358 of a multilayer circuit carrying element (e.g. on adjacent layers 350 and 352, adjacent layers 352 and 354, etc.). A multilayer coil system may include coils in at least three, at least four, at least five, and/or at least six, at least eight, and/or at least ten conductive layers 350-358 of the circuit carrying element 210. A multilayer coil system may include coils that border at least two, at least four, at least six, at least eight, at least ten, at least fourteen, and/or at least eighteen different surfaces of non-conductive layers 312-318 of a circuit carrying element 210.

Referring to FIG. 5, a coil system 214 having multiple coils may also include multiple coils arranged on the same surface of the circuit carrying element 210. The coils may be adjacent to each other on the surface (e.g. without other circuit components between the coils), may be arranged such that one or more coils is not adjacent to other coils, may be arranged such that none of the coils are adjacent, and/or may be arranged such that at least some of the coils are adjacent to each other. Coils arranged adjacent to each other may create a broader field. A multiple coil system 214 having multiple coils on a single surface may include at least two, at least three, at least four, at least five, and/or at least six coils arranged on the surface. In one exemplary embodiment, a circuit carrying element includes two coils on a single surface of the multilayer circuit carrying element.

In addition to having a multilayer coil system 214 having a single coil on each of the multiple layers, the multilayer coil system may include multiple coils on more than one of the layers. For example, the multilayer coil system may include at least two, at least three, at least four, at least five, and/or at least six different layers of coils each having multiple coils (e.g. each having one of the numbers discussed above). The multilayer coil system may include multiple coils on each of the layers of the coil system, some but not all of the layers, one of the layers, or none of the layers.

A circuit carrying element that has a coil system 214 having multiple coils (e.g. a multilayer coil system, a side by side coil system, etc.) may include at least three, at least four, at least five, and/or at least six coils. A coil system 214 may be arranged on at least two surfaces and/or may include at least two coils.

The coils of the multi-layer coil system may be driven by a common drive signal and may be driven in parallel and/or may be driven serially. At least one coil from each layer (or substantially all of the layers) of a multi-layer coil system 214 may be configured such that current flows through those coils in the same direction.

A coil may be formed as any of a variety of shapes, including a round shape (e.g. any shape having rounded features such that the rounded features constitute at least about half of the perimeter of the structure, including circular shapes, ovoid shapes, etc.), a polygonal shape (e.g. any polygonal shape including polygonal shapes having rounded features so long as the rounded features account for less than half of the perimeter of the coil), a linear shape (e.g. a straight line, a curved line, multiple parallel lines, etc.), and/or some other shape. For coil systems having multiple coils, the coils can be the same shape, similar shapes, the same type of shape, different shapes, different types of shapes, a plurality having the same or similar shape and one or more having different shapes, or any other combination.

One or more coils (e.g. each) of a coil system 214 may cover an area of the circuit carrying element of at least about 10 mm², 15 mm², 25 mm², 50 mm², 100 mm², 150 mm², and/or 3 cm². One or more coils (e.g. each) of a coil system 214 may cover an area of the circuit carrying element of up to about 150 mm², 3 cm², 5 cm², 10 cm², 25 cm², and/or 50 cm². In other embodiments, one or more coils of a coil system 214 may cover an area of the circuit carrying element of more than 50 cm² or less than 10 mm².

One or more coils of a coil system 214 may have a perimeter of at least about 10 mm, 15 mm, 20 mm, 35 mm, 50 mm, and/or 75 mm. One or more coils of a coil system 214 may have a perimeter of up to about 50 mm, 60 mm, 75 mm, 100 mm, 150 mm, and/or 200 mm. In other embodiments, one or more coils of a coil system 214 may have a perimeter of more than 200 mm or less than 10 mm.

One or more coils of a coil system 214 may have a length of at least about 3 cm, 5 cm, 7 cm, 10 cm, 15 cm, 20 cm, 30 cm, and/or 40 cm. One or more coils of a coil system 214 may have a length of up to about 10 m, 1 m, 75 cm, 50 cm, 40 cm, 30 cm, 20 cm, 10 cm and/or 5 cm. In other embodiments, one or more coils of a coil system 214 may have a length of more than 10 m or less than 3 cm.

One or more coils of a coil system 214 may have a height of at least about 0.2 mils, 0.5 mils, 1 mil, 1.5 mils, 2 mils, and/or 2.5 mils. One or more coils of a coil system 214 may have a height of up to about 1.5 mils, 2 mils, 2.5 mils, 3 mils, 5 mils, 8 mils, 10 mils, and/or 12 mils. In other embodiments, one or more coils of a coil system 214 may have a height of more than 12 mils or less then 0.2 mils.

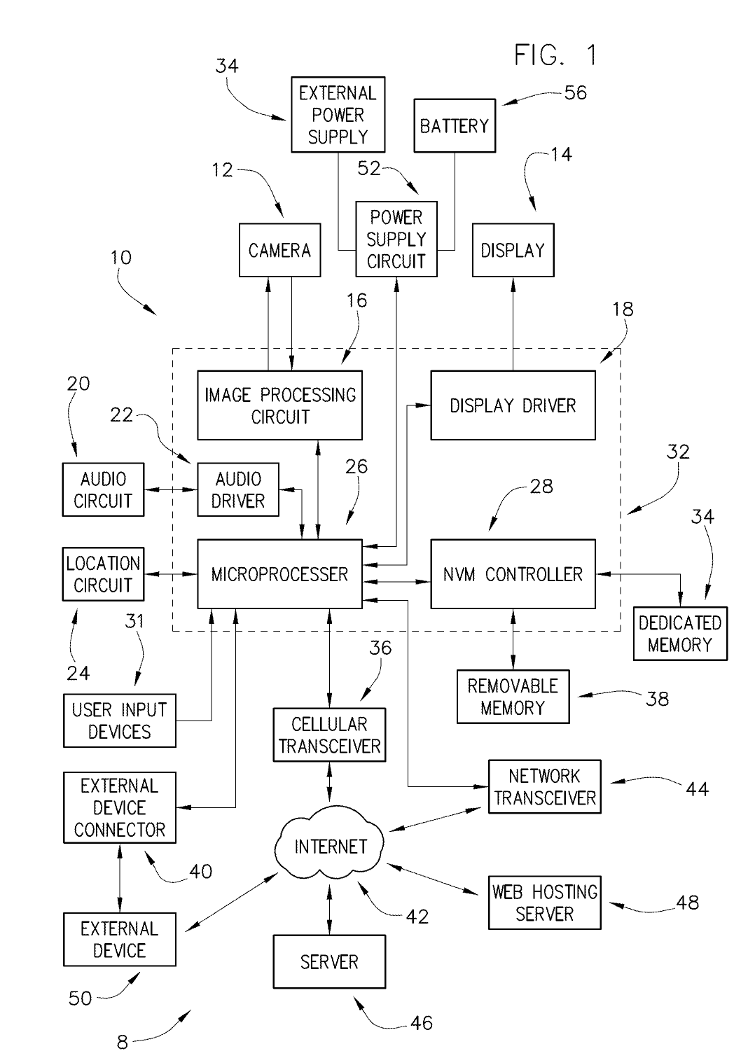

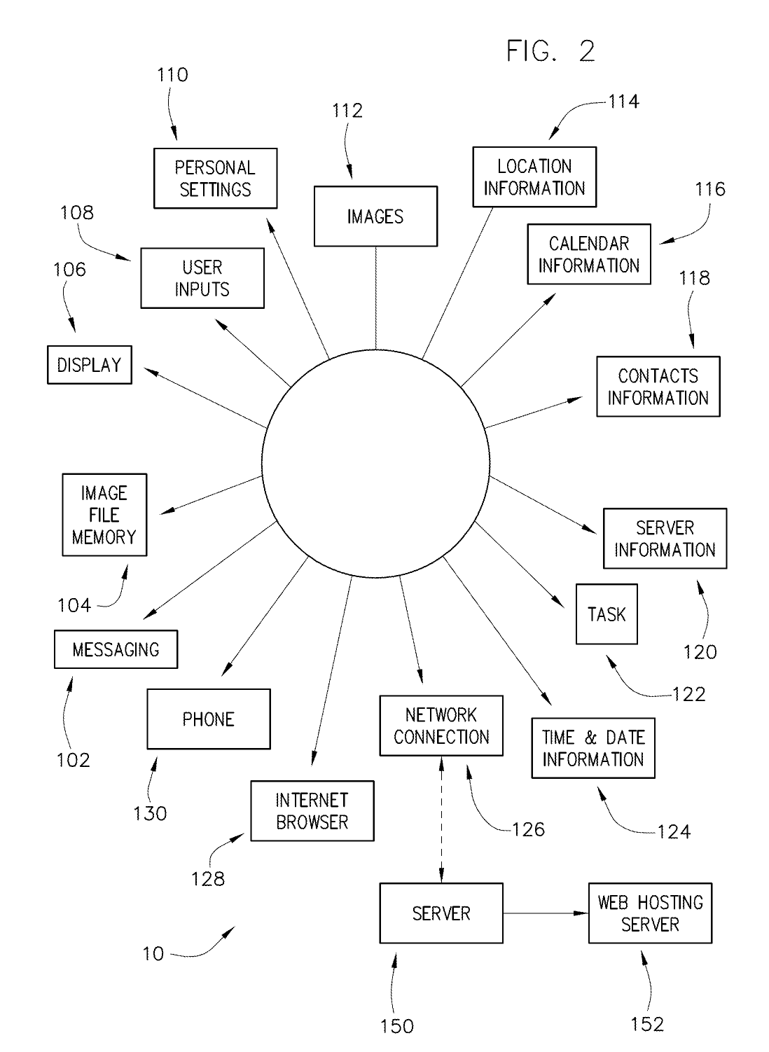

Referring to FIG. 3, circuit carrying element 210 may also be configured to carry a plurality of dice 218-228, a drive circuit 212, a receiver transducer 216, and/or a microphone 230. Dice 218-228 may include other components of a wireless (e.g. cellular) phone. For example, die 218 may include an applications processing unit (e.g. a microprocessor) configured to implement applications such as those discussed with respect to FIG. 2 and die 228 may include a wireless communications processing unit (e.g. a microprocessor and/or a digital signal processor) configured to facilitate wireless communications (e.g. voice data and/or non-voice data) with a communication network (e.g. a cellular communication network). Die 218 may be configured to use a volatile memory 220 and/or non-volatile memory 222 to store and execute applications (see, e.g. FIG. 2) and data related to the applications. Die 228 may be configured to use a volatile memory 224 and/or a non-volatile memory 226 to store and/or execute programs configured to facilitate wireless communication.

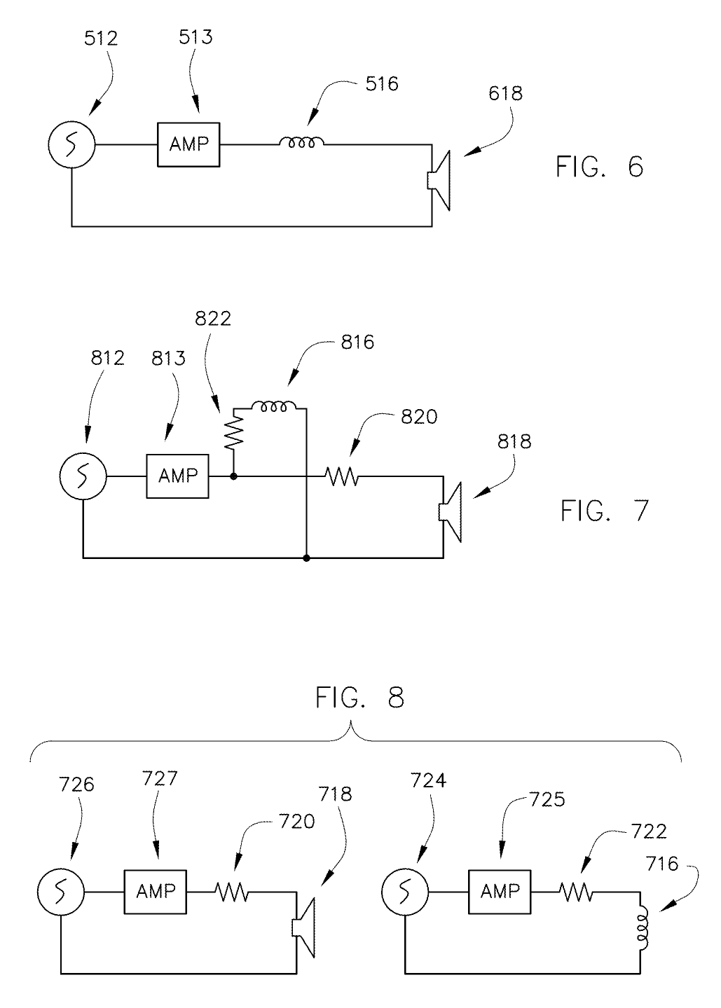

Die 228 may be configured to receive signals containing voice data from the communications network and provide the voice data to the die 218. Die 218 may be configured to receive the voice data, process the data (e.g. using a phone application), and provide an output signal to a drive circuit 212, 412 based on the data. Drive circuit 212 may be configured to drive the coil system 214 and receiver transducer 216 in parallel (see, e.g. FIGS. 3 and 7) or in series (see, e.g. FIGS. 5 and 6). Die 218 could also be configured to provide output signals to different drive circuits in order to drive the coil system 214 and receiver transducer 216 separately (see, e.g. FIG. 8).

As illustrated in FIG. 5, microphone 230 may be isolated from other portions of circuit board 210 using perforations. See, e.g., U.S. patent application Ser. No. 11/787,657, the disclosure of which is hereby incorporated by reference in its entirety to the extent that it is consistent with the present disclosure.

Referring to FIGS. 3 and 5, receiver transducer 216 may be configured to provide private audible signals (i.e. not speakerphone audible signals), may be configured to provide speakerphone audible signals, and/or may be configured to provide both private and speakerphone audible signals. An audio output port configured to be connected to an external speaker could also be used in place of or in addition to receiver transducer 216.

Referring to FIG. 6, the receiver transducer 518 and the coil system 516 can be driven in series by a single drive signal. A signal source 512 (e.g. a processing unit) provides a signal which is amplified by an amplifier 513. The amplified signal is provided to one or more coils 516 of a coil system and a receiver transducer 518 in series with the coil 516.

Referring to FIG. 7, the receiver transducer and the coil system can be driven in parallel from a single drive signal. A signal source 812 provides a signal which is amplified by an amplifier 813. The amplified signal is provided in parallel to one or more coils 816 of a coil system and to a receiver transducer 818. The coil 816 may be in series with a resistor 822 and/or the receiver transducer 618 may be in series with a resistor 820. The resistors 820, 822 may be selected such that different currents can be provided to the receiver transducer 818 and coil 816 using a single amplified drive signal from amplifier 813. Further, other signal processing circuitry may be provided in the path of coil 816 and/or receiver transducer 818 to modify the signal provided to each part 816,818.

Referring to FIG. 8, the receiver transducer 718 and the coil system 716 can be driven separately. A first signal source 726 provides a first signal which is amplified by a first amplifier 727 to drive the receiver transducer 718. A second signal source 724 (e.g. different pins of a processing unit) provides a second signal which is amplified by a second amplifier 725 to drive one or more coils 716 of a coil system.

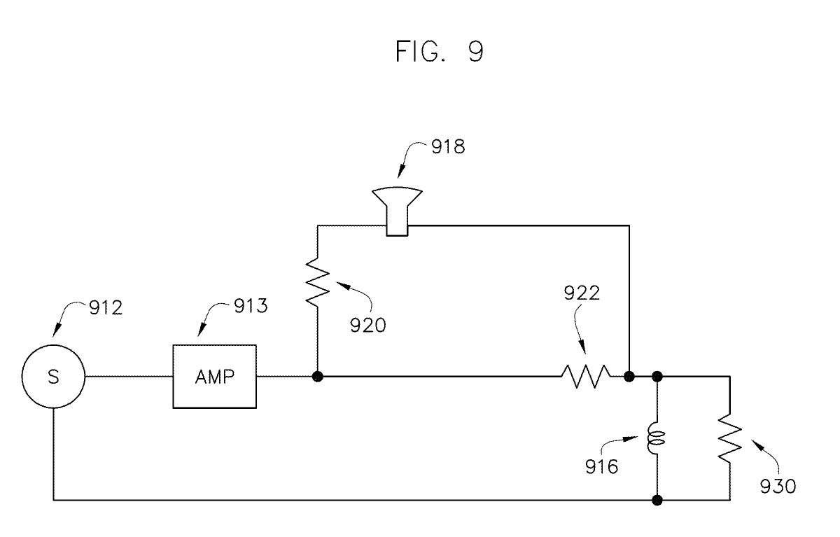

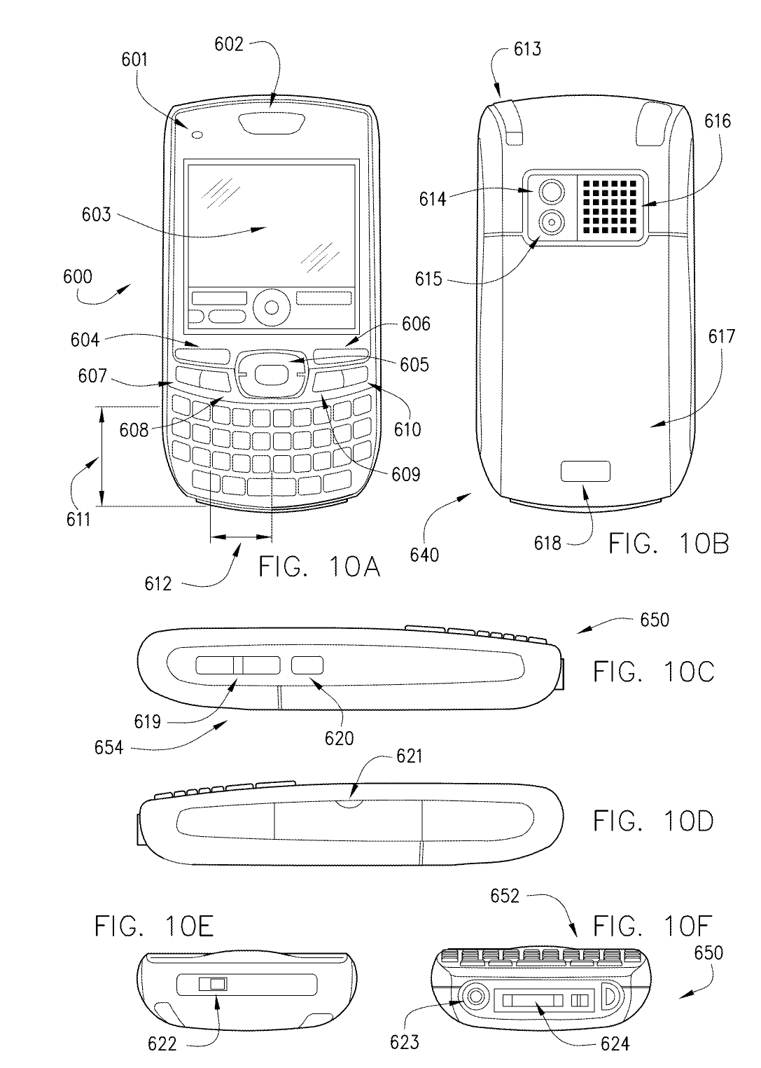

Referring to FIG. 9, the receiver transducer 918 and coil system 916 may be both driven in series (in part) and in parallel (in part). A signal source 912 provides a signal which is amplified by an amplifier 913. The amplified signal passes through a resistor 920 and then to a speaker 918. From speaker 918, the signal passes to a coil system 916 and a resistor 930 in parallel, thereby driving the receiver transducer 918 and coil system 916 in series (in part). The amplified signal from amplifier 913 also passes through resistor 922 which then passes through coil system 916 and resistor 930, bypassing receiver transducer 918, thereby driving receiver transducer 918 and coil system 916 in parallel (in part). The values of resistors 920, 922, and 930 may be set at any range, and may be set to optimize the power provided to each of receiver transducer 918 and coil system 916 based on the requirements and performance of a particular receiver transducer 918 and/or coil system 916. In some embodiments, one or more of resistors 920, 922, and 930 may have a variable resistance, which variable resistance may be controlled by a system of the phone.

Referring again to FIGS. 3-5, circuit carrying element 210 may be a circuit board (e.g. a printed circuit board), may be a flexible circuit, may be an inflexible circuit having a non-planar shape, may be an inflexible circuit board having a non-uniform thickness, and/or may be some other type of circuit carrying element. Circuit carrying element 210 may comprise a laminate substrate, a silicon substrate, may be formed from glass, may be formed from wood, may be formed from metal, may be formed from plastic, may be formed from fabric, may be formed from a foam, may include one or more resins, may be formed from a tape, may be formed from a film, may be a multilayer element, may be a prepeg element, may be a cored element, may be a hollow core element, and/or may have some other property.

It should be understood that while a few components are illustrated as being on circuit carrying element 210 in FIGS. 3-5, that circuit carrying element 210 will generally be configured to carry a substantial number of other circuit components. For example, circuit carrying element 210 may be configured to carry a camera, an image processor, informational lights (e.g. LEDs such as OLEDs or semiconductor LEDs, other solid state lighting elements, etc.), circuits for a user input device, radio, Integrated Circuits, one or more antennas (e.g. RF antennas), one or more oscillators (e.g. crystal oscillators), transducers, any of the wireless phone components discussed above or below, various miscellaneous circuit components (e.g. transistors, resistors, capacitors, etc.) used to implement one of the various devices and/or functions listed in the application, etc.

Also, while all of the components illustrated as being carried by circuit carrying element 210 are illustrated as being on a same face of a same layer of circuit carrying element 210, the various components may be on different external faces of circuit carrying element 210, may be on the same or different internal faces of a multilayer circuit carrying element, etc. For components on different faces, any number of techniques can be used to couple the components shown or described as being connected to each other. For example, a connection can be made by one or more of solder balls or columns, vias, wire bonds, flip chip connections, etc. Components such as a surface mounted microphone 230 may be configured to face either the front or bottom of the mobile device. Components such as a receiver transducer 216 for use in private communications may be configured to face a front of the mobile device, while a speaker (not illustrated) for use in speakerphone communications may be configured to face a rear of the mobile device.

### EXAMPLES

### Example 1

In one exemplary embodiment, a multilayer circuit board includes six conductive layers 350-358 and five non-conductive layers 312-318. The embodiment includes six coils on six different conductive layers 350-358 of a multilayer circuit carrying element 210, having coils on ten different surfaces of the non-conductive layers of the multilayer circuit carrying element.

The coils are formed in a rounded spiral patterns where the spiral from the coil on the first (external) conductive layer spirals in towards the center of the spiral, the coil on the second conductive layer spirals out towards the perimeter of the spiral, the coil on the third conductive layer spirals in, the coil on the fourth conductive layer spirals out, the coil on the fifth conductive layer spirals in, and the coil on the sixth conductive layer spirals out. The coils (and the spirals of the coils) are all centered on a common axis.

Each coil is formed within an area of 6 mm by 6 mm, the diameter of the outside spiral being about 6 mm. The width of the conductive element forming each coil is about 0.004 inches (100 μm). The height of the conductive element forming each strand is about 1.4 inches (1 oz).

The coils are connected to a coil of an adjacent conductive layer by one of five vias formed in the circuit board; three near the center of the coils, and two near the perimeter of the coils.

The coils are formed on an area of a printed circuit board proximate to the receiver transducer. The printed circuit board is also configured to carry a microphone, an applications processing unit, a modem processing unit, non-volatile memory, volatile memory, a display driver, user interface circuits, an audio driver, and other circuit components of a wireless phone.

### Example 2

In another exemplary embodiment, a multilayer circuit carrying element includes eight conductive layers 350-358 and seven non-conductive layers 312-318. The embodiment includes eight coils on eight different conductive layers 350-358 of a multilayer circuit carrying element 210, having coils on fourteen different surfaces of the non-conductive layers of the multilayer circuit carrying element.

The coils are formed in a square spiral pattern where the spiral from the coil on the first (external) conductive layer spirals in towards the center of the spiral, the coil on the second conductive layer spirals out towards the perimeter of the spiral, the coil on the third conductive layer spirals in, the coil on the fourth conductive layer spirals out, the coil on the fifth conductive layer spirals in, the coil on the sixth conductive layer spirals out, the coil on the seventh layer spirals in, and the coil on the eighth layer spirals out. The coils (and the spirals of the coils) are all centered on a common axis.

Each coil formed on an internal conductive layer is formed within an area of 20 mm by 20 mm, and the coils formed on the external conductive layers are formed within an area of 12 mm by 12 mm. The width of the conductive element forming each coil is about 0.002 inches (50 μm). The height of the conductive element forming each strand is about 0.7 inches (0.5 oz).

The coils are connected to a coil of an adjacent conductive layer by one of seven vias formed in the circuit board; four near the center of the coils, and three near the perimeter of the coils. The vias near the center of the coils are blind vias extending through a single non-conductive layer.

The coils are formed on an area of a printed circuit board proximate to the receiver transducer. The printed circuit board is also configured to carry a microphone, an applications processing unit, a modem processing unit, non-volatile memory, volatile memory, a display driver, user interface circuits, an audio driver, and other circuit components of a wireless phone.

### Example 3

In another exemplary embodiment, a multilayer circuit carrying element includes twelve conductive layers 350-358 and eleven non-conductive layers 312-318. The embodiment includes twelve coils on twelve different conductive layers 350-358 of a multilayer circuit carrying element 210, having coils on twenty-two different surfaces of the non-conductive layers of the multilayer circuit carrying element.

The coils are formed in a rounded spiral patterns where the spiral from the coil on the first (external) conductive layer spirals in towards the center of the spiral, the coil on the second conductive layer spirals out towards the perimeter of the spiral, the coil on the third conductive layer spirals in, the coil on the fourth conductive layer spirals out, the coil on the fifth conductive layer spirals in, the coil on the sixth conductive layer spirals out, the coil on the seventh conductive layer spirals in, the coil on the eighth conductive layer spirals out, the coil on the ninth conductive layer spirals in, the coil on the tenth conductive layer spirals out, the coil on the eleventh conductive layer spirals in, and the coil on the twelfth conductive layer spirals out. The coils (and the spirals of the coils) are all centered on a common axis.

Each coil is formed within an area of 12 mm by 12 mm, the diameter of the outside spiral being about 12 mm. The width of the conductive element forming each coil is about 0.003 inches (75 μm). The height of the conductive element forming each strand is about 1.4 inches (1 oz).

The coils are connected to a coil of an adjacent conductive layer by one of twelve vias formed in the circuit board; six near the center of the coils, and six near the perimeter of the coils.

### Example 4

A phone includes a coil as discussed in Example 3. The phone includes a first circuit board that carries a microphone, an applications processing unit, a modem processing unit, non-volatile memory, volatile memory, a display driver, user interface circuits, an audio driver, and other circuit components of a wireless phone. A receiver transducer is connected to the first circuit board by a flexible connector. The circuit board of example 3 is a second circuit board that is placed proximate to the receiver transducer and connected to the flexible connector.

### Example 5

A phone includes a coil as discussed in Example 3. The phone includes a circuit board that carries a microphone, an applications processing unit, a modem processing unit, non-volatile memory, volatile memory, a display driver, user interface circuits, an audio driver, and other circuit components of a wireless phone. A coil system is formed as discussed above in Example 1, except that the coils are formed in a flex circuit. The flex circuit carries a receiver transducer and is connected to the circuit board carrying the components of the phone.

### Other Features

Referring back to FIG. 1, portable device 10 may be a mobile computing device capable of executing software programs. The device 10 may be implemented as a combination handheld computer and mobile telephone, sometimes referred to as a smart phone. Examples of smart phones include, for example, Palm® products such as Palm® Treo™ smart phones. Although some embodiments may be described with portable device 10 implemented as a smart phone by way of example, it may be appreciated that the embodiments are not limited in this context. For example, portable device 10 may comprise, or be implemented as, any type of wireless device, mobile station, or portable computing device with a self-contained power source (e.g., battery) such as a laptop computer, ultra-laptop computer, personal digital assistant (PDA), cellular telephone, combination cellular telephone/PDA, mobile unit, subscriber station, user terminal, portable computer, handheld computer, palmtop computer, wearable computer, media player, camera, pager, messaging device, data communication device, and so forth.

Processing circuit 32 of hand-held device 10 may include one or more of a microprocessor 26, image processing circuit 16, display driver 18, NVM controller 28, audio driver 22 (e.g. D/A converter, A/D converter, an audio coder and/or decoder (codec), amplifier, etc.), and other processing circuits. Processing circuit 32 can include various types of processing circuitry, digital and/or analog, and may include one or more of a microprocessor, microcontroller, application-specific integrated circuit (ASIC), field programmable gate array (FPGA), or other circuitry configured to perform various input/output, control, analysis, and other functions. In various embodiments, the processing circuit 32 may include a central processing unit (CPU) using any suitable processor or logic device, such as a as a general purpose processor. Processing circuit 32 may include, or be implemented as, a chip multiprocessor (CMP), dedicated processor, embedded processor, media processor, input/output (I/O) processor, co-processor, a microprocessor such as a complex instruction set computer (CISC) microprocessor, a reduced instruction set computing (RISC) microprocessor, and/or a very long instruction word (VLIW) microprocessor, a processor implementing a combination of instruction sets, a controller, a microcontroller, an application specific integrated circuit (ASIC), a field programmable gate array (FPGA), a programmable logic device (PLD), or other processing device in accordance with the described embodiments.

Processing circuit 32 may be configured to digitize data, to filter data, to analyze data, to combine data, to output command signals, and/or to process data in some other manner. Processing circuit 32 may be configured to perform digital-to-analog conversion (DAC), analog-to-digital conversion (ADC), modulation, demodulation, encoding, decoding, encryption, decryption, etc. Processing circuit 32 (e.g. microprocessor 26) may be configured to execute various software programs such as application programs and system programs to provide computing and processing operations for device 10.

Processing circuit 32 may also include a memory that stores data. Processing circuit may include only one of a type of component (e.g. one microprocessor), or may contain multiple components of that type (e.g. multiple microprocessors). Processing circuit 32 could be composed of a plurality of separate circuits and discrete circuit elements. In some embodiments, processing circuit 32 will essentially comprise solid state electronic components such as a microprocessor (e.g. microcontroller). Processing circuit 32 may be mounted on a single board in a single location or may be spread throughout multiple locations which cooperate to act as processing circuit 32. In some embodiments, processing circuit 32 may be located in a single location and/or all the components of processing circuit 32 will be closely connected.

Components shown as part of a single processing circuit 32 in the figures may be parts of separate processing circuits in various embodiments covered by the claims unless limited by the claim to a single processing circuit (e.g. location circuit 24 may be part of a separate assembly having a separate microprocessor that interfaces with processing circuit 32 through data port 40).

Hand-held device 10 may also include a network transceiver 44. Transceiver 44 may operate using one or more of a LAN standard, a WLAN standard, a Bluetooth standard, a Wi-Fi standard, an Ethernet standard, and/or some other standard. Network transceiver 44 may be a wireless transceiver such as a Bluetooth transceiver and/or a wireless Ethernet transceiver. Wireless transceiver 44 may operate using an IEEE 802.11 standard. Hand-held device 10 may also include an external device connector 40 (such as a serial data port) for transferring data. External device connector 40 may also serve as the connector 52 to an external power supply. Hand-held device may contain more than one of each of transceiver 44 and external device connector 40. For example, network transceiver 44 may include both a Bluetooth and an IEEE 802.11 transceiver.

Network transceiver 44 may be arranged to provide voice and/or data communications functionality in accordance with different types of wireless network systems. Examples of wireless network systems may include a wireless local area network (WLAN) system, wireless metropolitan area network (WMAN) system, wireless wide area network (WWAN) system, and so forth. Examples of wireless network systems offering data communication services may include the Institute of Electrical and Electronics Engineers (IEEE) 802.xx series of protocols, such as the IEEE 802.11a/b/g/n series of standard protocols and variants (sometimes referred to as “WiFi”), the IEEE 802.16 series of standard protocols and variants (sometimes referred to as “WiMAX”), the IEEE 802.20 series of standard protocols and variants, and so forth.

Hand-held device 10 may be capable of operating as a mobile phone. The mobile phone may use transceiver 44 and/or may use a cellular transceiver 36. Cellular transceiver 36 may be configured to operate as an analog transceiver, a digital transceiver (e.g. a GSM transceiver, a TDMA transceiver, a CDMA transceiver), or some other type of transceiver. Cellular transceiver 36 may be configured to transfer data (such as image files) and may be used to access the Internet 42 in addition to allowing voice communication. Cellular transceiver 36 may be configured to use one or more of an EV-technology (e.g. EV-DO, EV-DV, etc.), an EDGE technology, a WCDMA technology, and/or some other technology.

Transceiver 44 may be arranged to perform data communications in accordance with different types of shorter range wireless systems, such as a wireless personal area network (PAN) system. One example of a wireless PAN system offering data communication services includes a Bluetooth system operating in accordance with the Bluetooth Special Interest Group (SIG) series of protocols, including Bluetooth Specification versions v1.0, v1.1, v1.2, v2.0, v2.0 with Enhanced Data Rate (EDR), etc.—as well as one or more Bluetooth Profiles, etc. Other examples may include systems using an infrared technique.

Cellular transceiver 36 may provide voice communications functionality in accordance with different types of cellular radiotelephone systems. Examples of cellular radiotelephone systems may include Code Division Multiple Access (CDMA) cellular radiotelephone communication systems, Global System for Mobile Communications (GSM) cellular radiotelephone systems, North American Digital Cellular (NADC) cellular radiotelephone systems, Time Division Multiple Access (TDMA) cellular radiotelephone systems, Extended-TDMA (E-TDMA) cellular radiotelephone systems, Narrowband Advanced Mobile Phone Service (NAMPS) cellular radiotelephone systems, third generation (3G) systems such as Wide-band CDMA (WCDMA), CDMA-2000, Universal Mobile Telephone System (UMTS) cellular radiotelephone systems compliant with the Third-Generation Partnership Project (3GPP), and so forth.

In addition to voice communications functionality, the cellular transceiver 36 may be arranged to provide data communications functionality in accordance with different types of cellular radiotelephone systems. Examples of cellular radiotelephone systems offering data communications services may include GSM with General Packet Radio Service (GPRS) systems (GSM/GPRS), CDMA/1xRTT systems, Enhanced Data Rates for Global Evolution (EDGE) systems, Evolution Data Only or Evolution Data Optimized (EV-DO) systems, Evolution For Data and Voice (EV-DV) systems, High Speed Downlink Packet Access (HSDPA) systems, High Speed Uplink Packet Access (HSUPA), and so forth.

Hand-held device 10 may include one or more user input devices 31 (e.g. button, switch, touch screen, keyboard, keypad, voice command circuit, etc.) for registering commands from a user on device 10. Some or all of user input devices 31 may interface with a switch control circuit (not shown) configured to interpret which switches have been actuated. User input device 31 may include an alphanumeric keyboard. The keyboard may comprise, for example, a QWERTY key layout and an integrated number dial pad. A keyboard integrated into a hand-held device would typically be a thumb keyboard. User input device 31 may also include various keys, buttons, and switches such as, for example, input keys, preset and programmable hot keys, left and right action buttons, a navigation button such as a multidirectional navigation button, phone/send and power/end buttons, preset and programmable shortcut buttons, a volume rocker switch, a ringer on/off switch having a vibrate mode, and so forth. Any of user input devices 31 may be concealable behind a body (e.g. a sliding body, a flip-out body, etc.) such that they are hidden when the body is in a first position and visible when the body is in the second position.

Hand-held device 10 may include one or more location determining circuits 24 (e.g. a GPS circuit and/or a cell-based location determining circuit) configured to determine the location of device 10. Device 10 may be configured to receive inputs from more than one location determining circuit 24. These inputs can be compared such that both are used, one (e.g. a cell-based system) can be used primarily when the other (e.g. GPS) is unable to provide reliable location information, or can have some other functional relationship.

Device 10 may use one or more different location determining techniques to derive the location of the device 10 based on the data from location determining circuit 24.

For example, device 10 may use one or more of Global Positioning System (GPS) techniques, Cell Global Identity (CGI) techniques, CGI including timing advance (TA) techniques, Enhanced Forward Link Trilateration (EFLT) techniques, Time Difference of Arrival (TDOA) techniques, Angle of Arrival (AOA) techniques, Advanced Forward Link Trilateration (AFTL) techniques, Observed Time Difference of Arrival (OTDOA), Enhanced Observed Time Difference (EOTD) techniques, Assisted GPS (AGPS) techniques, hybrid techniques (e.g., GPS/CGI, AGPS/CGI, GPS/AFTL or AGPS/AFTL for CDMA networks, GPS/EOTD or AGPS/EOTD for GSM/GPRS networks, GPS/OTDOA or AGPS/OTDOA for UMTS networks), and so forth.

Device 10 may be arranged to operate in one or more position determination modes including, for example, a standalone mode, a mobile station (MS) assisted mode, and/or a MS-based mode. In a standalone mode, such as a standalone GPS mode, the mobile computing device 100 may be arranged to autonomously determine its position without network interaction or support. When operating in an MS-assisted mode or an MS-based mode, however, device 10 may be arranged communicate over a radio access network (e.g., UMTS radio access network) with a position determination entity (PDE) such as a location proxy server (LPS) and/or a mobile positioning center (MPC).

In an MS-assisted mode, such as an MS-assisted AGPS mode, the PDE may be arranged to determine the position of the mobile computing device. In an MS-based mode, such as an MS-based AGPS mode, device 10 may be arranged to determine its position with only limited periodic assistance from the PDE. In various implementations, device 10 and the PDE may be arranged to communicate according a suitable MS-PDE protocol (e.g., MS-LPS or MS-MPC protocol) such as the TIA/EIA standard IS-801 message protocol for MS-assisted and MS-based sessions in a CDMA radiotelephone system.

When assisting device 10, the PDE may handle various processing operations and also may provide information to aid position determination. Examples of assisting information may include satellite-based measurements, terrestrial-based measurements, and/or system-based measurements such as satellite almanac information, GPS code phase measurements, ionospheric data, ephemeris data, time correction information, altitude estimates, timing offsets, forward/reverse link calibration, and so forth.

In various implementations, the assisting information provided by the PDE may improve the speed of satellite acquisition and the probability of a position fix by concentrating the search for a GPS signal and/or may improve the accuracy of position determination. Each position fix or series of position fixes may be available at device 10 and/or at the PDE depending on the position determination mode. In some cases, data calls may be made and assisting information may be sent to device 10 from the PDE for every position fix. In other cases, data calls may be made and assistance information may be sent periodically and/or as needed.

Hand-held device 10 may include one or more audio circuits 20 (e.g. receiver transducers, microphone, etc.) for providing or receiving audio information to or from a user. In one example, hand-held device 10 includes a first receiver transducer 20 designed for regular phone operation. Hand-held device 10 may also include a second receiver transducer 20 for louder applications such as receiver transducer phone operation, music or other audio playback (e.g. an mp3 player application), etc. Hand-held device 10 may also include one or more audio ports 20 (e.g. a headphone connector) for output to an external receiver transducer and/or input from an external microphone. Audio circuit 20 may be under the control of one or more audio drivers 22 which may include D/A converters and/or an amplifier.

Hand-held device 10 may include a camera 12 for taking pictures using device 10. Camera 12 may include a CCD sensor, a CMOS sensor, or some other type of image sensor capable of obtaining an image (particularly, images sensors capable of obtaining an image formed as an array of pixels). The image sensor may have a resolution of at least about 65,000 pixels or at least about 1 megapixel. In some embodiments, the image sensor may have a resolution of at least about 4 megapixels. Camera 12 may also include read-out electronics for reading data from the image sensor. Image processing circuit 16 may be coupled to the camera 12 for processing an image obtained by the camera. This image processing may include format conversion (e.g. RGB to YCbCr), white balancing, tone correction, edge correction, red-eye reduction, compression, CFA interpolation, etc. Image processing circuit 16 may be dedicated hardware that has been optimized for performing image processing.

Hand-held device 10 may include a display 14 for displaying information to a user. Display 14 could be one or more of an LCD display (e.g. a touch-sensitive color thin-film transistor (TFT) LCD screen), an electroluminescent display, a carbon-nanotube-based display, a plasma display, an organic light emitting diode (OLED) display, and some other type of display. Display 14 may be a touch screen display such that a user may input commands by approaching (e.g. touching) display 14 (including touch screens that require a specialized device to input information). Display 14 may be a color display (e.g., 16 or more bit color display) or may be a non-color (e.g. monotone) display. Display 14 may be controlled by a display driver 18 that is under the control of a microprocessor 26. In some embodiments, display 14 may be used with a stylus. Display 14 may be used as an input to a handwriting recognizer application.

Hand-held device 10 may include a dedicated memory 34 fixed to device 10. Memory 34 may be implemented using any machine-readable or computer-readable media capable of storing data such as erasable or non-erasable memory, writeable or re-writeable memory, and so forth. Dedicated memory 34 may be a non-volatile memory, may be a volatile memory, or may include both volatile and non-volatile memories. Examples of machine-readable storage media may include, without limitation, random-access memory (RAM), dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory, ovonic memory, ferroelectric memory, silicon-oxide-nitride-oxide-silicon (SONOS) memory, magnetic or optical cards, or any other type of media suitable for storing information. In one embodiment, fixed memory 34 is a non-volatile memory.

Although the memory 34 is shown as being separate from and external to processing circuit 32 some portion or the entire memory 34 may be included on the same integrated circuit as processing circuit 32 (e.g. the same integrated circuit as microprocessor 26).

Hand-held device 10 may include a removable memory port 38 configured to receive a removable memory medium, and/or other components. Removable memory port 38 may also serve as an external device connector 40. For example, removable memory port may be an SDIO card slot which can be used to receive memory cards, receive cards input and/or output data, and combined cards having both memory and input/output functions.

Memory 34 and/or memory 38 may be arranged to store one or more software programs to be executed by processing circuit 32.

Dedicated memory 34 and removable memory 38 may be connected to and/or under the control of a common memory controller 28 such as a nonvolatile memory controller. Memory controller 28 may be configured to control reading of data to and writing of data from dedicated memory 34 and/or removable memory 38.

Handheld device 10 may be configured to connect to one or more servers 46,48 via a network 42 (such as the Internet) using one or more of network transceiver 44, cellular transceiver 36, and external device connector 40.

Hand-held device 10 may also include a power supply circuit 52 configured to regulate power supply in hand-held device 10. Power supply circuit 52 may be configured to do one or more of control charging of battery 56, to communicate the amount of power remaining in battery 56, determine and/or communicate whether an external power supply is connected, switch between the external power supply and the battery, etc. Battery 56 may be a rechargeable battery and may be removable or may be fixed to device 10. Battery 56 may be formed from any number of types of batteries including silver-based batteries (e.g. silver-zinc, magnesium-silver-chloride, etc.), a lithium-based battery (e.g. lithium-ion, lithium-polymer, etc.), a nickel-based battery (nickel-cadmium, nickel-metal-hydride, etc.), zinc-based batteries (e.g. silver-zinc, carbon-zinc, etc.), etc. External power supply connector 34 may be configured to be connected to a direct current source, an alternating current source, or both DC and AC sources.

Device 10 may have an optical viewfinder (not shown), may use display 14 as a digital viewfinder, may include some other type of view finder, may include multiple types of view finders, or may not include a view finder.

Device 10 may be configured to connect to the Internet 42, which may be a direct connection (e.g. using cellular transceiver 36, external device connector 40, or network transceiver 44) or may be an indirect connection (e.g. routed through external device 50). Device 10 may receive information from and/or provide information to the Internet. Device 10 may include a web browser configured to display information received from the Internet (including information which may be optimized by the browser for display on portable device 10). Device 10 may connect to one or more remote servers 46,48 using the Internet. Device 10 could also connect to another personal electronic device 50 by way of the Internet.

Device 10 may comprise an antenna system (not illustrated) for transmitting and/or receiving electrical signals. Each of the transceivers 36,44 and/or location circuit 24 may include individual antennas or may include a common antenna system. The antenna system may include or be implemented as one or more internal antennas and/or external antennas.

Portable device 10 may comprise a subscriber identity module (SIM) coupled to processing circuit 32. The SIM may comprise, for example, a removable or non-removable smart card arranged to encrypt voice and data transmissions and to store user-specific data for allowing a voice or data communications network to identify and authenticate the user. The SIM may store data such as personal settings specific to the user.

Referring to FIG. 2, device 10 and/or processing circuit 32 may be configured to run any number of different types of applications. Examples of application programs may include, for example, a phone application 130 (e.g. a telephone application, a voicemail application, a VoIP application, etc.), a messaging application 102 (e.g. an e-mail application, an instant message (IM) application, a short message service (SMS) application, a multimedia message service (MMS) application), a web browser application 128, a personal setting application 110 (e.g. a personal information manager (PIM) application), a contact management application 118, a calendar application 116 (e.g. a calendar application, a scheduling application, etc.), a task management application 122, a document application (e.g. a word processing application, a spreadsheet application, a slide application, a document viewer application, a database application, etc.), a location application 114 (e.g. a positioning application, a navigation application, etc.), an image application 112 (e.g. a camera application such as a digital camera application and/or a video camera application, an image management application, etc.) including media player applications (e.g. a video player application, an audio player application, a multimedia player application, etc.), a gaming application, a handwriting recognition application, and so forth. The application software may provide a graphical user interface (GUI) to communicate information between the portable device 10 and a user.

Device 10 may include a location application 114. Location application 114 may be configured to calculate the current position (e.g. the rough current position) of device 10 based on data received from one or more location circuits 24. Location application 114 may be provided with map information such that it can translate coordinate positions into map positions (and vice versa). Location application 114 may be configured to provide navigational information to a user such as turn by turn directions.

Device 10 may include personal organizer applications such as a calendar application 116, a contacts application 118, and a task application (not illustrated). Calendar application 116 may allow a user to schedule events, set alarms for events, and store a wide variety of information for events (e.g. name of the event, location of the event, other attendees of the event, etc.). Contacts application 118 may allow a user to save contact information for a contact such as phone number information (which may be shared with a phone application 130), address information, group information (e.g. which user created group or groups the contact belongs to), and other information about the contact. The task application allows a user to keep track of pending and/or completed tasks.

Device 10 may include an internal clock application 124 that keeps track of time information (such as current time of day and/or date), time zone information, daylight savings time information, etc. Clock application 124 may be a program running based on data from an internal clock of microprocessor 26, data from a separate clock/timing circuit, or data from some other circuit.

Device 10 may also include one or more network connection protocol applications 126 that allow a user to transfer data over one or more networks. Network application 126 may be configured to allow device 10 to access a remote device such as server 46,48.

Device 10 may include an Internet browser application 128 that allows a user to browse the internet. The Internet browser application may be configured to alter the data received from Internet sites so that the data can be easily viewed on portable device 10.

Device 10 may include a phone application 130 configured to allow a user to make phone calls. Phone application 130 may use contact information from contact application II 8 to place phone calls.

Device 10 may also include one or more messaging applications 102 that allow a user to send and/or receive messages such as text messages, multi-media messages, e-mails, etc. E-mail messages may come from a server which may use a Push technology and/or may use a pull technology (e.g. POP3, IMAP, etc.).

Any of the information discussed above for any of the applications (e.g. applications 102-128) may be added to or otherwise associated with an image file.

Referring to FIGS. 1 and 8A-8F, a hand-held portable computing device 600 (e.g. smartphone) includes a number of user input devices 31. The user input devices include a send button 604 configured to select options appearing on display 603 and/or send messages, a 5-way navigator 605 configured to navigate through options appearing on display 603, a power/end button 606 configured to select options appearing on display 603 and to turn on display 603, a phone button 607 usable to access a phone application screen, a calendar button 608 usable to access a calendar application screen, a messaging button 609 usable to access a messaging application screen, an applications button 610 usable to access a screen showing available applications, a thumb keyboard 611 (which includes a phone dial pad 612 usable to dial during a phone application), a volume button 619 usable to adjust the volume of audio output of device 600, a customizeable button 620 which a user may customize to perform various functions, a ringer switch 622 usable to switch the smartphone from one mode to another mode (such as switching from a normal ringer mode to a meeting ringer mode), and a touch screen display 603 usable to select control options displayed on display 603. Touch screen display 603 is also a color LCD display 14 having a TFT matrix.

Smartphone 600 also includes audio circuits 20. The audio circuits 20 include phone receiver transducer 602 usable to listen to information in a normal phone mode, external receiver transducer 616 louder than the phone receiver transducer (e.g. for listening to music, for a speakerphone mode, etc.), headset jack 623 to which a user can attach an external headset which may include a receiver transducer and/or a microphone, and microphone 625 which can be used to pick up audio information such as the user's end of a conversation during a phone call.

Smartphone 600 also includes a status indicator 601 that can be used to indicate the status of Smartphone 600 (such as messages pending, charging, low battery, etc.), a stylus slot 613 for receiving a stylus such as a stylus usable to input data on touch screen display 603, a digital camera 615 (see camera 12) usable to capture images, a mirror 614 positioned proximate camera 615 such that a user may view themselves in mirror 614 when taking a picture of themselves using camera 615, a removable battery 618 (see battery 56), and a connector 624 (see external data connector 40 and external power supply 34) which can be used to connect device 600 to either (or both) an external power supply such as a wall outlet or battery charger or an external device such as a personal computer, a gps unit, a display unit, or some other external device.

Smartphone 600 also includes an expansion slot 621 (see removable memory 38) which may be used to receive a memory card and/or a device which communicates data through slot 621, and a SIM card slot 617, located behind battery 618, configured to receive a SIM card or other card that allows the user to access a cellular network.

In various embodiments device 10 and device 600 may include a housing 640. Housing 640 could be any size, shape, and dimension. In some embodiments, housing 640 has a width 652 (shorter dimension) of no more than about 200 mm or no more than about 100 mm. According to some of these embodiments, housing 640 has a width 652 of no more than about 85 mm or no more than about 65 mm. According to some embodiments, housing 640 has a width 652 of at least about 30 mm or at least about 50 mm. According to some of these embodiments, housing 640 has a width 652 of at least about 55 mm.

In some embodiments, housing 640 has a length 654 (longer dimension) of no more than about 200 mm or no more than about 150 mm. According to some of these embodiments, housing 640 has a length 654 of no more than about 135 mm or no more than about 125 mm. According to some embodiments, housing 640 has a length 654 of at least about 70 mm or at least about 100 mm. According to some of these embodiments, housing 640 has a length 654 of at least about 110 mm.

In some embodiments, housing 640 has a thickness 650 (smallest dimension) of no more than about 150 mm or no more than about 50 mm. According to some of these embodiments, housing 640 has a thickness 650 of no more than about 30 mm or no more than about 25 mm. According to some embodiments, housing 640 has a thickness 650 of at least about 10 mm or at least about 15 mm. According to some of these embodiments, housing 640 has a thickness 650 of at least about 50 mm.

While described with regards to a hand-held device, many embodiments are usable with portable devices which are not handheld and/or with non-portable devices/systems.

The various single applications discussed above may be performed by multiple applications where more than one application performs all of the functions discussed for the application or where one application only performs some of the functions discussed for the application. For example, the image application 112 may be divided into an image capturing application and a separate image viewing application. Also, more than one application may be included on device 10 that is capable of displaying images as described for image application 112.

Further, while shown as separate applications above, many of the above listed applications can be combined into single applications that perform all or some of the functions listed for more than one of the applications discussed above.

While some components in FIG. 1 were discussed as being singular and others were discussed as being plural, the invention is not limited to devices having these same numbers of each type of component. Embodiments are conceived where each combination of plural and singular components exist.

In some embodiments, the various components shown in FIG. 1 may be combined in a single component. For example, in some embodiments, removable memory 38 may also be an external device connector 40 (such as an SDIO card slot which can be used to receive memory cards, input and/or output data, and combined devices having both memory and input/output functions). As another example, in some embodiments, a single connector could serve as both an external device connector 40 and as a connection to an external power supply 34.

Also, in some embodiments, the function of various claim components shown in FIG. 1 may be performed by a combination of distinct electrical components. For instance, a location circuit 24 may have a separate microprocessor that works in combination with the main microprocessor 26 of the system to perform the functions of the processing circuit 32. As another example, image processing circuit 16 may make use of the electronics of camera 12 to perform image processing, while also having other, discrete electronic components.

What is claimed is:

1. A wireless phone, comprising:
a wireless transceiver configured to facilitate wireless transfer of signals containing audio information, the wireless transceiver configured to receive signals containing audio information;
a processing circuit coupled to the wireless transceiver and configured to receive audio data based on the audio signals received by the wireless transceiver and provide output audio signals based on the audio data; and
a coil formed in a circuit carrying element, the coil configured to receive a signal based on the output audio signals from the processing circuit and to at least provide an output signal receivable by a hearing aid that is not intelligible by a human ear.

2. The wireless phone of claim 1, wherein the coil is formed from at least one of printed circuit board etch material and copper that is at least one of printed and etched on the circuit carrying element.

3. The wireless phone of claim 1, wherein the circuit carrying element carries a multiplicity of circuit components, the plurality of circuit components comprising at least one die.

4. The wireless phone of claim 1, further comprising a plurality of coils, the plurality of coils cooperating to provide the output receivable by a hearing aid.

5. The wireless phone of claim 4, wherein the circuit carrying element is a multilayer circuit carrying element and at least two of the plurality of coils are formed in separate layers of the circuit carrying element.

6. The wireless phone of claim 5, wherein the plurality of coils are at least partially overlapping.

7. The wireless phone of claim 5, wherein the plurality of coils comprise coils on at least three layers of the circuit carrying element.

8. The wireless phone of claim 5, wherein the plurality of coils comprise coils on at least five layers of the circuit carrying element.

9. The wireless phone of claim 4, wherein the plurality of coils are configured to be powered by a common drive signal.

10. The wireless phone of claim 4, wherein at least two of the plurality of coils are on a common surface of the circuit carrying element.

11. The wireless phone of claim 1, wherein the coil is at least one of a rounded shape and a polygonal shape.

12. The wireless phone of claim 1, further comprising a receiver transducer configured to be driven by the processing circuit to provide private audible signals, the coil being driven in parallel to the receiver transducer.

13. The wireless phone of claim 12, further comprising at least one resistor configured to affect an amount of power provided to at least one of the receiver transducer and the coil so that the receiver transducer and the coil are driven differently.

14. The wireless phone of claim 12, wherein the coil and receiver transducer are further configured to be driven in series.

15. The wireless phone of claim 1, further comprising a receiver transducer configured to be driven by the processing circuit to provide private audible signals, the coil being driven in series with the receiver transducer.

16. The wireless phone of claim 1, further comprising a receiver transducer configured to be driven by the processing circuit to provide private audible signals, the coil being driven separately from the receiver transducer.

17. The wireless phone of claim 1, wherein at least the portion of the processing circuit configured to receive audio data based on the audio signals received by the wireless transceiver is provided on the circuit carrying element.

18. The wireless phone of claim 1, wherein the transceiver and the processing circuit are formed in a single chip.

19. The wireless phone of claim 1, further comprising a second circuit carrying element configured to carry the processing circuit.

20. A wireless phone, comprising:
a user input device;
a wireless transceiver configured to facilitate transfer of audio signals, the wireless transceiver configured to receive audio signals;
a processing circuit coupled to the wireless transceiver and configured to receive audio data based on the audio signals received by the wireless transceiver and provide output audio signals based on the audio data; and
a coil system formed on a circuit board, the coil system comprising at least three coils formed in at least three layers of the circuit board, the coil system being configured to receive the output audio signals from the processing circuit and to provide a magnetic output signal based on the output audio signals from the processing circuit.

21. A multilayer circuit board comprising:
a plurality of layers; and
multiple coils formed on the circuit board such that a wirelessly transmitted signal provided by the multiple coils is additive, the signal being a magnetic signal capable of transmitting audio information.

22. The circuit board of claim 21, further comprising dice provided on at least one of the layers.

23. The circuit board of claim 22, wherein the multiple coils are configured to be driven based on a signal from at least one of the dice.

24. The circuit board of claim 21, wherein the coils are configured to provide a signal that is detectable by a hearing aid.

25. The circuit board of claim 21, wherein the multiple coils are formed in different layers of the plurality of layers.
